(19) United States
(12) Patent Application Publication
(10) Pub. No.: US 2016/0029551 A1
(43) Pub. Date: Feb. 4, 2016

(54) Portable Hydroseeder

(71) Applicant: Anthony Michael Crivello, Winchester, CA (US)

(72) Inventor: Anthony Michael Crivello, Winchester, CA (US)

(21) Appl. No.: 14/448,032

(22) Filed: Jul. 31, 2014

(51) Int. Cl. A01C 7/06; A01C 7/00

(52) U.S. Cl. CPC A01C 7/06; A01C 7/004

(57) ABSTRACT

A portable hydroseeding system comprising a housing for containing a slurry, a propellant means connected to the housing and an outlet control mechanism for distributing the slurry.

### CROSS REFERENCE TO RELATED APPLICATIONS

The present Application is a continuation of U.S. patent application Ser. No. 13/01,684, filed on Jan. 28, 2011 which is the United States national phase application of International Patent Application No. PCT/US09/51178, titled “Portable Hydroseeder,” filed Jul. 20, 2009, which claims the benefit of U.S. provisional patent application 61/082,455, filed Jul. 21, 2008, entitled “A spot hydroseeder/fertilizer that a typical homeowner can connect to a garden hose for spot seeding for lawn, slope, ground cover, flower beds, pastures, herb gardens or virtually any seed that one would like to propagate. You may also fertilize any plot of earth by using a granulated or liquid fertilizer,” and from U.S. Provisional Patent Application No. 61/208,508, filed Feb. 25, 2009, entitled “A hand held spot hydroseeder that a typical homeowner can connect to a garden hose for spot seeding for a lawn, slope, ground cover, flower beds, pastures, herb gardens or virtually any seed one would like to propagate,” the contents of which are incorporated herein by reference in their entirety.

### FIELD

The invention pertains to hydro-seeding and more specifically a hydroseeding system that is economical, efficient and portable.

### BACKGROUND

Hydroseeding (or hydraulic mulch seeding, hydro-mulching, hydraseeding) is a planting process that uses a slurry of seed, fertilizer and mulch. The slurry is transported in a housing, either truck-mounted or trailer-mounted and sprayed over prepared ground in a uniform layer. Alternatively, helicopters and aircraft can be used where larger areas must be covered, such as, for example, burned wilderness areas after a fire. Hydroseeding is an alternative to the traditional process of broadcasting or sowing dry seed and promotes quick germination and inhibits soil erosion. Hydroseeding is used to seed grass on commercial sites (highways/motorways etc.), golf courses, lawns and areas too large, inaccessible or unsuitable for conventional methods. Starting a lawn by hydroseeding is considerably cheaper than laying sod/turf and quicker than using dry seed. It is also used to spread mixtures of wildflower and tree/shrub seeds or turf grasses for erosion control. Hydroseeding typically has similar costs to dry seeding techniques that combine seed with straw mulch. Further, the hydroseeding slurry is weed free whereas straw mulch can contain weeds. Also, hydroseeding is typically less than ¼ the cost of laying sod.

Disadvantageously, there has never been a portable hydroseeder due to the pressure required to eject the mulch. As described in U.S. Pat. No. 3,717,285, hydroseeding is currently done by hiring a contractor that has a truck with separate housings for the water and dry ingredients (mulch, seed, color etc.) and an agitator pump to mix the water and the dry ingredients to produce a slurry that can then be spread over a large area. U.S. Pat. No. 4,913,356 describes a portable seeding device that uses suction, using the venturi effect, to lift a mixture of water and seed from a jar. The constriction required to lift the seed and water out of the jar using the venturi effect is insufficient to allow any mulch to be added to the jar. Additionally, the amount of seed and mulch required to cover at least a one square foot area would make the jar extremely large and unwieldy.

Therefore, there is a need for a hydroseeder that is economical, efficient and portable that overcomes the problems in the prior art.

### SUMMARY

The problems in the prior art have been successfully overcome by the present invention, which is directed to a portable hydroseeding system and method. The system comprises a portable housing means for containing a slurry, a propellant means connected to the housing and an outlet control means for distributing the slurry. The propellant means can be a standard garden hose water connection, a carbon dioxide connection, an inflatable lining, a mechanical plunger, a piston, a low pressure air connection, and a high pressure air connection. Preferably, the propellant connection is a standard garden hose.

The housing further comprises an upper housing portion and a lower housing portion, an inlet control valve connected to the propellant, a pressure gauge connected to the upper housing portion, a jet nozzle internally connected to the upper housing portion for spraying the pressurized water into the housing, a lower housing portion attachable to the upper housing portion for containing a mixture of dry ingredients to form a slurry, an exit control valve for controlling the discharge of slurry from the combined upper housing portion and the lower housing portion, and an applicator nozzle connected to the lower housing portion for distributing the slurry over an area. In one embodiment, a removable threaded agitator lid is connected to the inlet control valve of the housing. An output port is connected to the housing and an outlet control valve is connected to the output port to regulate the distribution of the slurry. In another embodiment, the outlet control valve further comprises a slurry supply hose for ease of use while distributing the slurry. In another embodiment, a second outlet control valve attached to the output port is provided for further control of the pressure in the housing.

The housing, one or more than one water hose attachments, inlet control valve, threaded agitator lid, output port, and second outlet control valve can be constructed from wood, plastic, aluminum, steel, fiberglass, carbon fiber, polyethylene, resin, vinyl, and glass, but preferably from stainless steel.

In one embodiment, the lid further comprises an upper water jet housing, a plurality of upper water jets, a water shaft, a paddle agitator, and optionally a plurality of lower water jets connected to the tank. Optionally, the threaded agitator lid can further comprise a mixing shaft for external agitation.

There is provided a method for using the portable hydroseeding system comprising the steps of: a) removing thatch or dead vegetation from one or more than one areas to be seeded; b) loosening soil for the one or more than one areas to be seeded; c) placing the hydroseeder proximate to one of the one or more than one areas to be seeded; d) connecting the hydroseeder to a propellant source; e) opening the hydroseeder; f) adding dry ingredients to the hydroseeder; g) closing the hydroseeder; h) opening the inlet valve starting a flow of propellant to create a slurry; i) opening the outlet control valve; j) applying the slurry to the loosened earth until the housing becomes empty or the slurry is free of seed; and k) repeating steps c through j until all areas are seeded.

### DRAWINGS

These and other features, aspects and advantages of the present invention will become better understood with regard to the following description, appended claims, and accompanying figure where:

FIG. 1A is a schematic diagram of a handheld hydroseeding system that is economical, efficient and portable according to one embodiment of the present invention;

FIG. 1B is a schematic diagram of a piston-driven handheld hydroseeding system that is economical, efficient and portable according to another embodiment of the present invention;

FIG. 2 is a schematic diagram of a hydroseeding system that is economical, efficient and portable according to another embodiment of the present invention; and

FIG. 3 is a flowchart diagram of some steps of a method for using the hydroseeder shown in FIGS. 1 and 2.

### DETAILED DESCRIPTION

The present invention solves the problems with the prior art by providing a hydroseeder that is economically feasible for an individual to own, and is efficient because in one embodiment the hydroseeder only requires a regular garden hose to operate and is portable so that the individual user can use the hydroseeder anywhere at any time without the need to hire a commercial contractor with a massive hydroseeding vehicle as required by the prior art. Additionally, a separate agitating pump is not needed, as the present invention is a portable or hand held hydroseeder which anyone can use to propagate a slurry of seed, fertilizer and mulch using any municipal water source, such as, for example, a garden hose, or other propellants. The portable hydroseeder unit is lightweight, compact, reusable and can be easily stored. The portable hydroseeder described herein has the capabilities of large commercial hydroseeders with compact and portable convenience.

As used in this disclosure, except where the context requires otherwise, the term “comprise” and variations of the term, such as “comprising”, “comprises” and “comprised” are not intended to exclude other additives, components, integers or steps.

The term “slurry” refers to a mixture of water, seed and mulch with other additives, such as, fertilizer, coloring agent and weed killer or pre-made mixtures, such as, for example, Scotts® Patchmaster® products among others.

The term “portable” refers to a device that can be transported from location to location by no more than two persons and preferably only one person.

In the following description, specific details are given to provide a thorough understanding of the embodiments. However, it will be understood by one of ordinary skill in the art that the embodiments can be practiced without these specific details. For example, circuits can be shown in block diagrams in order not to obscure the embodiments in unnecessary detail. In other instances, well-known circuits, structures and techniques can be shown in detail.

Also, it is noted that the embodiments can be described as a process that is depicted as a flowchart, a flow diagram, a structure diagram, or a block diagram. Although a flowchart can describe the operations as a sequential process, many of the operations can be performed in parallel or concurrently. In addition, the order of the operations can be rearranged. A process is terminated when its operations are completed.

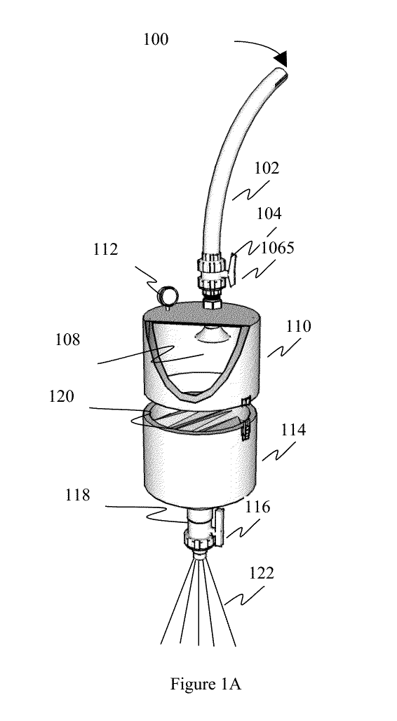

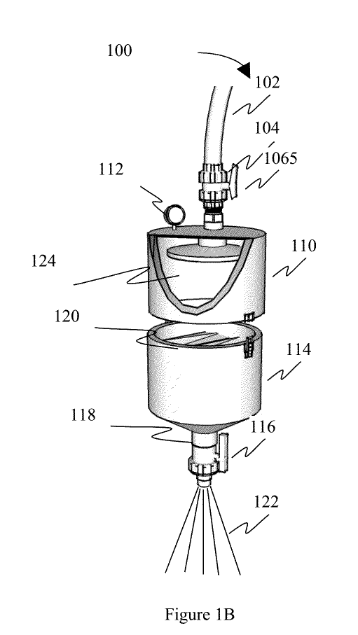

As can be seen in FIG. 1A, there is shown a schematic diagram of a handheld hydroseeding system 100 that is economical, efficient and portable according to one embodiment of the present invention. The handheld hydroseeding system 100 comprises a water hose 102 attachment 104 connected to a water control valve 106. The water control valve 106 controls the amount of water provided to a jet nozzle 108 located inside an upper housing portion 110. A pressure gauge 112 is also attached to the upper housing portion 110 so that the user can observe when water pressure inside a combined upper housing portion 110 and a lower housing portion 114 is sufficient for operation of the hydroseeding system 100. An applicator nozzle 118 is attached to the lower housing portion 114. The upper housing portion 110 provides space for the incoming water to flow into the lower housing portion 114 containing a dry mixture 120 of fertilizer, seed and mulch. The upper housing portion 110 and the lower housing portion 114 are connected together to form the housing 110 and 114 by any typical means known in the art, such as, for example, clamps and screw fittings, to remain joined while under the pressure applied by the propellant. The jet nozzle 108 forces the water completely into the dry mixture 120 making a slurry 122. The jet nozzle 108 is positioned so that the spray pattern forces all the dry mixture 120 into solution without leaving any dry mixture in the combined upper housing portion 110 and lower housing portion 114. The applicator nozzle 118 can be designed to spray various patterns, such as, for example, a square pattern, a round pattern, and rectangular pattern among others as will be understood by those with skill in the art with reference to this disclosure. An exit control valve 116 controls the discharge of the slurry 122 from the combined upper housing portion 110 and the lower housing portion 114.

FIG. 1B shows a schematic diagram of a handheld hydroseeding system 100 that is economical, efficient and portable according to another embodiment of the present invention. In this embodiment the elements of the hydroseeder described in FIG. 1A are identical with the exception of a plunging means 124 that replaces the jet nozzle 108 shown in FIG. 1A. The plunging means 124 can comprise various components, such as, for example, an inflatable rubber lining that expands to fill the housing 110 and 114, a hydraulic plunger or a piston among others that can push the slurry 122 out of the housing 110 and 114 only using pressure provided at the water hose attachment 102. Other propellants, such as, for example, carbon dioxide cartridges, compressed air cartridges, low pressure air lines, high pressure air lines, mechanical ratchet plungers, pistons and gravity flow can be used to distribute the slurry 122 from the hydroseeder 100 onto the area to be seeded.

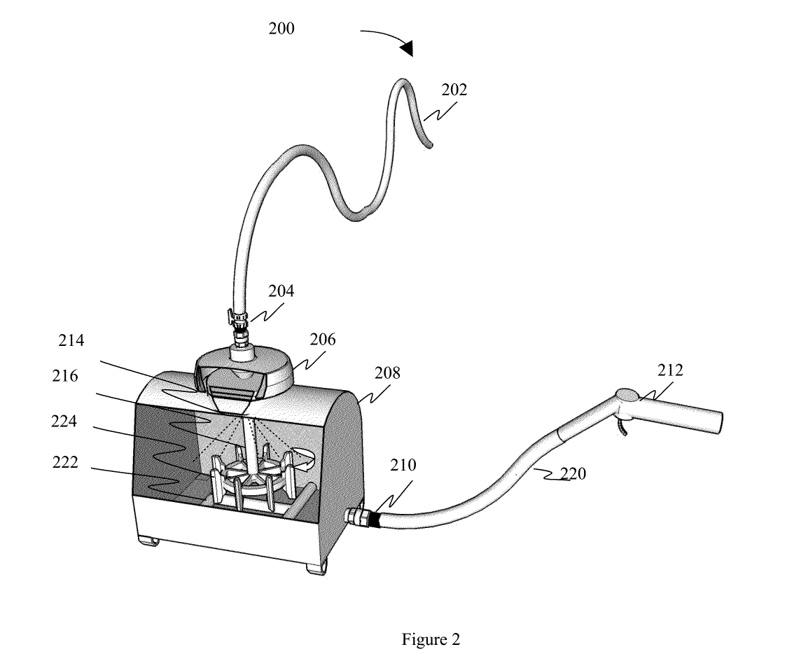

As can be seen in FIG. 2, there is shown a schematic diagram of a portable hydroseeding system 100 that is economical, efficient and portable according to another embodiment of the present invention. The hydroseeding system 200 comprises a water hose 202 attached to a first inlet control valve 204. The first inlet control valve 204 is connected to a removable threaded agitator lid 206 and provides water to pressurize housing 208. The lid 206 can be opened to insert a dry mixture of seed, mulch and other additives that when mixed with water will become the hydroseeding slurry. The lid 206 further comprises a plurality of upper water jets 214 connected to a paddle agitator 224. When inlet control valve 204 is opened, water will flow through the lid 206 and into the plurality of upper water jets 214. The water from the upper water jets 214 will convert the dry mixture into the slurry to be distributed. The pressure from the incoming water will force the slurry to the output port 210. The threaded agitator lid 206 can further comprise a mixing shaft attachment (not shown) so that a user can connect a drill to provide agitation via a paddle agitator 224. Optionally, the hydroseeding system 200 further comprises a second inlet control valve (not shown) that supplies propellant to a set of lower water jets 222. The lower water jets 222 can provide additional mixing action to form the slurry and prevent the dry mixture from adhering to the tank 208.

Once sufficient water has been added, the water and dry ingredients will form the slurry and the housing 208 will be pressurized to the maximum amount from the supplied propellant so that the slurry can be forced out of the output port 210 to be distributed over an area to be seeded using only the pressure in the housing and the water pressure from the water hose 202. An outlet control valve 212 regulates the distribution of the slurry from the housing 208 to the area to be seeded. As can be appreciated, the outlet control valve 212 can be attached to a slurry supply hose 220 for ease of use. Optionally, a second outlet control valve can be attached to the output port 210 for further control of the pressure in the housing 208. It should further be noted that the lid 206, the housing 208 and the other elements that comprise the device can be made of various materials, such as, for example, wood, plastic, aluminum, steel, fiberglass, carbon fiber, polyethylene, resin, vinyl, glass, or any other sufficiently resilient material that can maintain the slurry under pressure. However, stainless steel is preferable due to its non-corrosive properties and ease of cleaning.

As can be appreciated, there are many possible variations. Among the variations contemplated include a cartridge system, where the dry mixture is present with the proper ratio of seed, mulch, fertilizer and other additives and is only used once. Additionally, a cartridge system comprising a premixed slurry and a non-water propellant, such as, for example, carbon dioxide (CO₂) or a compressed air canister is also contemplated for a portable system that does not require a water hose connection. The most basic form for a portable hydroseeding system comprises a housing for containing a slurry, a pressurizing propellant connected to the housing and an outlet control mechanism for distributing the slurry.

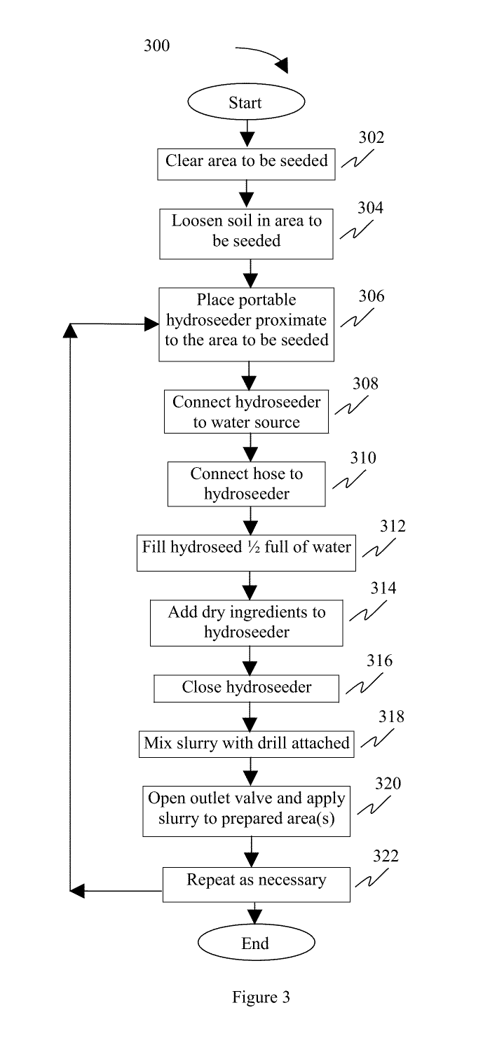

Referring now to FIG. 3, there is shown some steps 300 of a method for using the hydroseeder 100 or 200. First, thatch or dead vegetation is removed 302 from one or more than one areas to be seeded. Then, soil for the one or more than one areas to be seeded, is loosened 304 to provide better seed adhesion. Next, the hydroseeder 100 or 200 is placed 306 proximate to the area to be hydroseeded. Then, the hydroseeder 100 or 200 is connected to a pressurized water source 308 using a hose 102 or 202. Next, an optional slurry supply hose 220 is connected to the output 118 or 212 on the hydroseeder 100 or 200. Then, inlet valve 106 or 204 is opened starting a flow of pressurized water. Optionally, a second water hose can be connected 310 to the hydroseeder to provide a second source of water to insure complete mixing of dry ingredients into a slurry and to assist in pressurizing the hydroseeder. Next, the hydroseeder 100 or 200 is filled with water to ½ capacity 312 to prime the hydroseeder 100 or 200 for operation. Then, dry ingredients, such as, for example, seed, cellulose mulch and granulated or liquid pre-plant fertilizer are added 314 to the hydroseeder 100 or 200 to ¾ capacity. Next, the hydroseeder 100 or 200 is securely closed 316. Optionally, a drill can be temporarily connected to the hydroseeder 200 to mix the dry ingredients 318 with the water for 30-60 seconds. Then, the user opens the outlet control valve and applies the slurry 320 to the earth until the housing becomes empty or the slurry is free of seed. Repeat the steps 322 until all areas are seeded.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference in their entirety.

What is claimed is:

1. A portable hydroseeding system comprising:
a) a pressurized portable housing for containing a pressurized slurry, wherein the slurry comprises water, seed, fertilizer and additives;
b) a propellant connection connected to the housing; and
c) an outlet control mechanism connected to the housing for distributing the pressurized slurry.

2. The portable hydroseeding system of claim 1, where the propellant connection is selected from the group consisting of a standard garden hose water connection, a carbon dioxide connection, an inflatable lining, a mechanical plunger, a piston, a low pressure air connection, and a high pressure air connection.

3. The portable hydroseeding system of claim 1, where the propellant connection is a standard garden hose connection.

4. The portable hydroseeding system of claim 1, where the housing further comprises an upper housing portion and a lower housing portion.

5. The portable hydroseeding system of claim 4, further comprising:
a) an inlet control valve connected to the propellant connection;
b) a pressure gauge connected to the upper housing portion;
c) a jet nozzle internally connected to the upper housing portion for spraying the pressurized water into the housing;
d) a lower housing portion attachable to the upper housing portion for containing a mixture of dry ingredients to form a slurry;
e) an exit control valve for controlling the discharge of slurry from the combined upper housing portion and the lower housing portion; and
f) an applicator nozzle connected to the lower housing portion for distributing the slurry over an area.

6. The portable hydroseeding system of claim 3, further comprising:
a) a removable threaded agitator lid connected to an inlet control valve attachable to the housing;
b) an output connected to the housing; and
c) An outlet control valve connected to the output to regulate the distribution of a slurry from the housing.

7. The portable hydroseeding system of claim 6, wherein the outlet control valve further comprises a slurry supply hose for ease of use.

8. The portable hydroseeding system of claim 7, further comprising a second outlet control valve attached to the output for further control of the pressure in the housing.

9. The portable hydroseeding system of claim 8, wherein the housing, water hose attachment, inlet control valve, threaded agitator lid, output, and second outlet control valve are constructed from material selected from the group consisting of wood, plastic, aluminum, steel, fiberglass, carbon fiber, polyethylene, resin, vinyl, and glass.

10. The portable hydroseeding system of claim 9, wherein the housing, one or more than one water hose attachments, the first inlet control valve, the second inlet control valve, the threaded agitator lid, the output port, and the second outlet control valve are constructed from stainless steel.

11. The portable hydroseeding system of claim 6, wherein the lid further comprises:
a) an upper water jet housing;
b) a plurality of upper water jets connected to the upper water jet housing;
c) a water shaft connected to the plurality of upper water jets;
d) a paddle agitator connected to the water shaft; and
e) a plurality of lower water jets connected to a tank.

12. The portable hydroseeding system of claim 6, wherein the threaded agitator lid further comprises a mixing shaft for external agitation.

13. A method for using a portable hydroseeding system, the method comprising the steps of:
a) removing thatch or dead vegetation from one or more than one areas to be seeded;
b) loosening soil for the one or more than one areas to be seeded;
c) placing the hydroseeder proximate to one of the one or more than one areas to be seeded;
d) connecting the hydroseeder to a propellant source;
e) opening the hydroseeder;
f) adding dry ingredients to the hydroseeder;
g) closing the hydroseeder;
h) opening the inlet valve starting a flow of propellant to create a slurry;
i) opening the outlet control valve;
j) applying the slurry to the loosened earth until the housing becomes empty or the slurry is free of seed; and
k) repeating steps c through j until all areas are seeded.

14. The method of claim 10, further comprising the step of connecting a slurry supply hose to the output port on the hydroseeder.

15. The method of claim 13, further comprising the step of connecting a drill to the hydroseeder to mix the dry ingredients with the water.

16. A portable hydroseeding system comprising:
a) means for containing a slurry, wherein the means for containing the slurry further comprises a threaded agitator lid;
b) means for connecting a propellant to a housing; and
c) means for controlling the distribution of the slurry.

17. The portable hydroseeding system of claim 16, where the propellant connection means is selected from the group consisting of a standard garden hose water connection, a carbon dioxide connection, an inflatable lining, a mechanical plunger, a piston, a low pressure air connection, and a high pressure air connection.

18. The portable hydroseeding system of claim 17, where the propellant connection means is a standard garden hose connection.

19. The portable hydroseeding system of claim 17, further comprising:
a) a pressure gauge connected to the upper housing portion;
b) a jet nozzle internally connected to an upper housing portion;
c) a lower housing portion attachable to the upper housing portion;
d) an applicator nozzle connected to the lower housing portion; and
e) an exit control valve for controlling the discharge of slurry from the combined upper housing portion and the lower housing portion.

20. The portable hydroseeding system of claim 17, further comprising:
a) a removable threaded agitator lid connected to an inlet control valve attachable to the housing;
b) an output port connected to a lower portion of the housing; and
c) an outlet control valve connected to the output port to regulate the distribution of a slurry from the housing.

21. The portable hydroseeding system of claim 20, wherein the outlet control valve further comprises a slurry supply hose for ease of use.

22. The portable hydroseeding system of claim 20, further comprising a second outlet control valve attached to the output port for further control of the pressure in the housing.

23. The portable hydroseeding system of claim 22, wherein the housing, water hose attachment, inlet control valve, threaded agitator lid, output port, and second outlet control valve are constructed from material selected from the group consisting of wood, plastic, aluminum, steel, fiberglass, carbon fiber, polyethylene, resin, vinyl, and glass.

24. The portable hydroseeding system of claim 23, wherein the housing, a water hose attachment, inlet control valve, threaded agitator lid, output port, and second outlet control valve are constructed from stainless steel.

25. The portable hydroseeding system of claim 16, wherein the threaded agitator lid further comprises:
a) an upper water jet housing;
b) a plurality of upper water jets connected to the upper water jet housing;
c) a water shaft connected to the plurality of upper water jets;
d) a paddle agitator connected to the water shaft; and
e) a plurality of lower water jets connected to the tank.

26. The portable hydroseeding system of claim 25, wherein the threaded agitator lid further comprises a mixing shaft for external agitation.
